(19) United States
(12) Patent Application Publication
(10) Pub. No.: US 2022/0263969 A1
(43) Pub. Date: Aug. 18, 2022

(54) IMAGE TRANSMISSION APPARATUS, CONTROL METHOD OF IMAGE TRANSMISSION APPARATUS, AND STORAGE MEDIUM

(71) Applicant: CANON KABUSHIKI KAISHA, Tokyo (JP)

(72) Inventor: Mikio Hama, Toride-shi (JP)

(21) Appl. No.: 17/737,425

(22) Filed: May 5, 2022

Related U.S. Application Data
(63) Continuation of application No. 16/173,994, filed on Oct. 29, 2018.

(30) Foreign Application Priority Data
Nov. 2, 2017 (JP) 2017-213194

(51) Int. Cl. H04N 1/32; H04N 1/00

(52) U.S. Cl. CPC H04N 1/32048; H04N 2201/0094; H04N 1/00209; H04N 1/00331

(57) ABSTRACT

Some embodiments of a control method of an image transmission apparatus comprise reading a document to generate image data, recognizing character information of the image data, acquiring a plurality of addresses from the recognized character information, selecting an address from among a plurality of acquired addresses, and setting the address selected from the plurality of addresses as a transmission address.

### CROSS-REFERENCE TO RELATED APPLICATIONS

This application is a Continuation of U.S. patent application Ser. No. 16/173,994, filed Oct. 29, 2018, which claims the benefit of Japanese Patent Application No. 2017-213194, filed Nov. 2, 2017, both of which are hereby incorporated by reference herein in their entirety.

### BACKGROUND

### Field of the Disclosure

The present disclosure relates to an image transmission apparatus, a control method of the image transmission apparatus, and a storage medium.

### Description of the Related Art

There has been known a technique for setting address information, such as an address or a phone number described in a name card, as a transmission address for transmitting image data from an image transmission apparatus (hereinafter, referred to as “multi-function peripheral (MFP)”). In a technique discussed in Japanese Patent Application Laid-Open No. 2006-333041, when address information is to be acquired by reading a name card through an MFP, a phone number is acquired as address information and a fax is transmitted to the acquired address, in a case where a fax function is set to the MFP. Further, in a case where an internet fax function is set to the MFP, an e-mail address is acquired as the address information, and an e-mail is transmitted to the acquired address.

However, with a configuration described in the conventional technique, it is not possible for a user to select and set an address to a transmission address if a plurality of addresses is described on a name card.

### SUMMARY

According to some embodiments, an image transmission apparatus comprises a reading unit configured to read a document to generate image data, a character recognition unit configured to recognize character information of the image data, an acquisition unit configured to acquire a plurality of addresses from the character information recognized by the character recognition unit, a selecting unit configured to select an address from among a plurality of addresses acquired by the acquisition unit, and a setting unit configured to set the address selected by the selecting unit as a transmission address.

Further features of various embodiments will become apparent from the following description of exemplary embodiments with reference to the attached drawings.

### BRIEF DESCRIPTION OF THE DRAWINGS

FIG. 1 is a block diagram illustrating a network configuration.

FIG. 2 is a block diagram illustrating a configuration of a multi-function peripheral (MFP).

FIG. 3 is a diagram illustrating a menu screen of the MFP.

FIG. 4 is a diagram illustrating a transmission screen displayed on an operation unit when a transmission key is selected.

FIGS. 5A and 5B are name card reading screens displayed on the operation unit when a name card reading key is selected.

FIG. 6 is a flowchart illustrating name card information acquisition processing.

FIG. 7 is a diagram illustrating a name card reading result screen displayed on the operation unit after execution of the name card information acquisition processing.

FIGS. 8A, 8B, and 8C are diagrams illustrating transmission screens in which selected addresses are set as transmission addresses.

FIG. 9 is a flowchart illustrating transmission executed by the MFP.

FIG. 10, composed of FIG. 10A and FIG. 10B, is a flowchart illustrating registration of an address executed by the MFP.

FIGS. 11A and 11B are diagrams respectively illustrating an address book screen and a one-touch address book screen.

FIG. 12 is a diagram illustrating a fax transmission screen displayed on the operation unit when a fax key is selected.

FIGS. 13A and 13B are diagrams respectively illustrating new address registration screens of an address book and a one-touch address book.

### DESCRIPTION OF THE EMBODIMENTS

An exemplary embodiment will be described in detail with reference to the appended drawings. The embodiments described hereinafter are not intended to limit the claims, and not all of the combinations of features described in the exemplary embodiments are required in all embodiments.

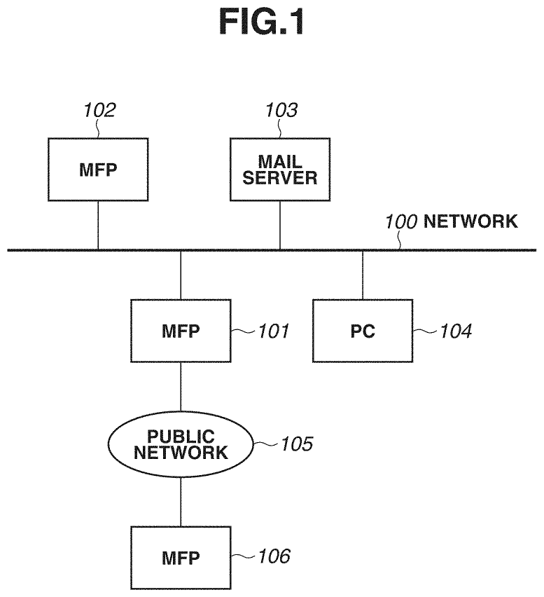

A first exemplary embodiment will be described in detail with reference to FIGS. 1 to 8. FIG. 1 is a block diagram illustrating a network configuration of the embodiment.

FIG. 1 illustrates an image transmission apparatus (hereinafter, referred to as “MFP 101”) as one example of a transmission source, and image transmission apparatuses (hereinafter, referred to as “MFP 102” and “MFP 106”) as examples of transmission destinations.

In FIG. 1, the MFP 101, the MFP 102, a mail server 103, and a personal computer (PC) 104 are communicably connected to each other via a network 100.

The MFP 101 and the MFP 106 are communicably connected to each other via a public network 105.

The MFP 101 transmits an e-mail including read image data to the MFP 102 or the PC 104 via the mail server 103.

The mail server 103 stores the e-mail received from the MFP 101 in a mailbox provided on a storage (not illustrated) as an e-mail that is to be received by the MFP 102.

The MFP 102 uses an e-mail reception account set thereto to receive the e-mail transmitted from the MFP 101 from the mailbox of the mail server 103.

The PC 104 uses an e-mail reception account set thereto to receive the e-mail transmitted from the MFP 101 from the mailbox of the mail server 103.

The MFP 106 receives a fax which the MFP 101 has transmitted by using a fax number.

In FIG. 1, the network 100 is described as a local network. However, for example, the internet or a network in any configuration, such as a network capable of transmitting data by wirelessly connecting to an access point (not illustrated), can be used as an effective communication unit.

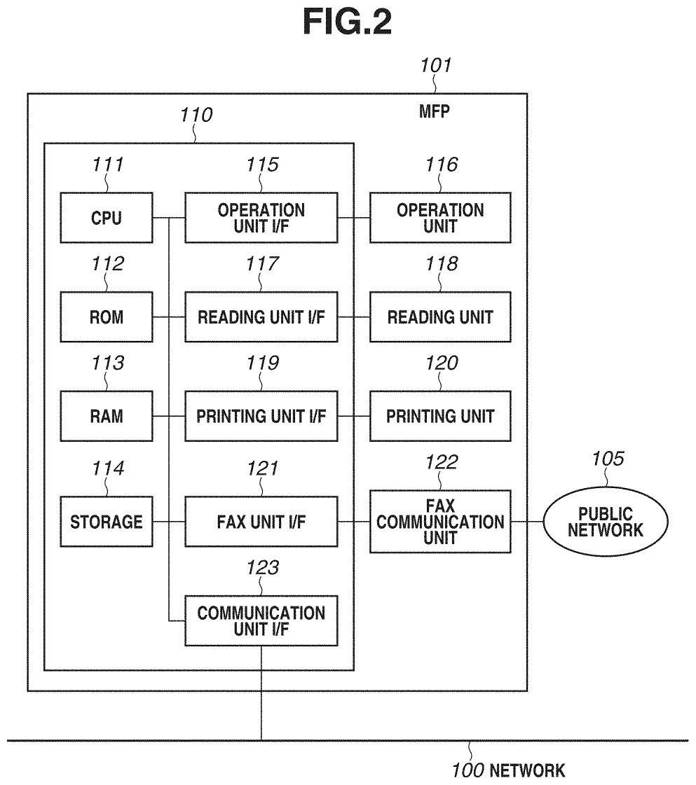

FIG. 2 is a block diagram illustrating a configuration of the MFP 101 in the present exemplary embodiment. A control unit 110 including a CPU 111 controls an entire operation of the MFP 101. For example, the CPU 111 reads a control program stored in a read only memory (ROM) 112 or a storage 114 to execute various types of control, such as conversion control and transmission control.

The ROM 112 stores a control program executable by the CPU 111. The ROM 112 further stores a boot program and font data. A random access memory (RAM) 113 is a main storage memory of the CPU 111 used as a work area or a temporary storage area for loading various control programs stored in the ROM 112 and the storage 114. The storage 114 stores image data, print data, various programs, and various types of setting information. In the present exemplary embodiment, although a flash memory is assumed as the storage 114, an auxiliary storage device, such as a solid state drive (SSD) or a hard disk drive (HDD), can be used therefor.

An operation unit interface (I/F) 115 connects an operation unit 116 and the control unit 110. The operation unit 116 serves as a display unit to display information to a user and detects an input from the user. A detected user input is notified to the CPU 111 via the operation unit I/F 115. Then, the CPU 111 executes control based on the notified input.

A reading unit I/F 117 connects a reading unit 118 and the control unit 110. The reading unit 118 reads an image on a document and converts the image into image data, such as binary data. The CPU 111 executes control for transmitting image data generated by the reading unit 118 to an external apparatus via a communication unit I/F 123.

Alternatively, the CPU 111 can execute control of inputting image data to a printing unit 120 via the reading unit I/F 117 or a printing unit I/F 119, and of making the printing unit 120 execute printing on a recording sheet based on the input image data. Further, the CPU 111 can execute control of saving image data generated by the reading unit 118 in the storage 114 via the reading unit I/F 117.

The printing unit I/F 119 connects the printing unit 120 and the control unit 110. The CPU 111 executes control of inputting image data as a printing target to the printing unit 120 via the printing unit I/F 119. The printing unit 120 prints an image on a recording sheet fed from a sheet feeding cassette.

The communication unit I/F 123 connects the control unit 110 and the network 100. The CPU 111 can execute control of transmitting image data or various types of internal information of the MFP 101 to an external apparatus connected to the network and receiving print data from the external apparatus via the communication unit I/F 123.

A transmission/reception method using an e-mail described as the above or a file transmission method using the other protocols (e.g., a file transfer protocol (FTP), a server message block (SMB), and web-based distributed authoring and versioning (WEBDAV)) is provided as a transmission/reception method through the network. However, the present exemplary embodiment is not limited to the above-described methods.

The CPU 111 controls a fax communication unit 122 through a fax unit I/F 121 to enable the MFP 101 to connect to the public network 105. The fax unit I/F 121 is an interface for controlling the fax communication unit 122. The CPU 111 controls a modem network control unit (NCU) for fax communication via the fax unit I/F 121 to connect the MFP 101 to the public network 105, or to execute control of fax communication protocols.

In the MFP 101 of the present exemplary embodiment, although one CPU 111 uses one memory (RAM 113) to execute respective processing illustrated in the below-described flowcharts, the configuration thereof is not limited thereto. For example, a plurality of CPUs, RAMs, ROMs, and storages can cooperatively execute respective processing illustrated in the below-described flowcharts. Further, a part of the processing can be executed by using a hardware circuit, such as an application specific integrated circuit (ASIC) or a field programmable gate array (FPGA).

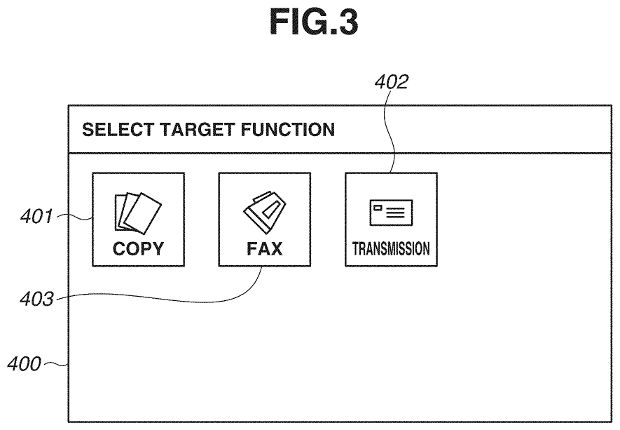

A menu screen 400 of the MFP 101 will be described with reference to FIG. 3. A copy key 401, a fax key 403, and a transmission key 402 are displayed on the menu screen 400 as illustrated in FIG. 3.

The user can use a copy function by selecting the copy key 401. The user can use fax as a transmission protocol by selecting the fax key 403 (i.e., a fax transmission function). A fax number can be set as a transmission address through the fax transmission function. The user can set a plurality of transmission protocols as transmission addresses by selecting the transmission key 402 (i.e., a transmission function). For example, in the transmission function, an e-mail address and a fax number can be set as the transmission addresses.

In FIG. 3, although the copy key 401, the fax key 403, and the transmission key 402 are illustrated as examples, keys which enable the user to use the other functions or a setting key can also be displayed.

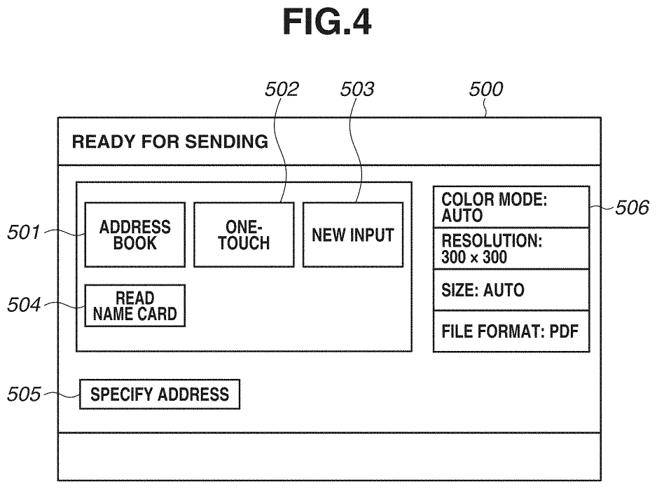

FIG. 4 illustrates a transmission screen 500 displayed on the operation unit 116 when the transmission key 402 in FIG. 3 is selected.

An address book key 501, a one-touch key 502, a new input key 503, a name card reading key 504, an address specification key 505, and a transmission information setting area 506 are arranged on the transmission screen 500 in FIG. 4.

A screen of an address book (an address book function) is displayed when the address book key 501 is selected. A screen of a one-touch address book (a one-touch address book function) is displayed when the one-touch key 502 is selected. The one-touch address book is a function which allows a user to register a commonly-used address as a one-touch address.

A new address input screen is displayed when the new input key 503 is selected.

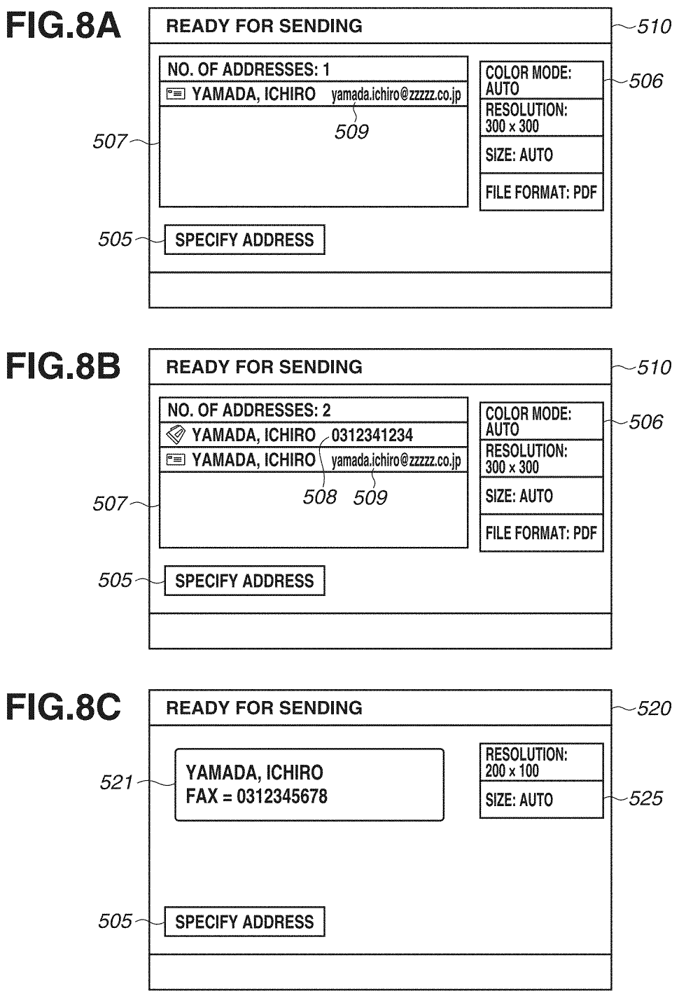

A transmission screen 510 in FIG. 8A (or 8B), on which a transmission address is set, and the transmission screen 500 in FIG. 4 are switched, when the address specification key 505 is selected.

Information of various types are arranged on the transmission information setting area 506, and the user selects the transmission information setting area 506 to specify a color mode, a resolution, a document size, and a file format of the image data to be transmitted.

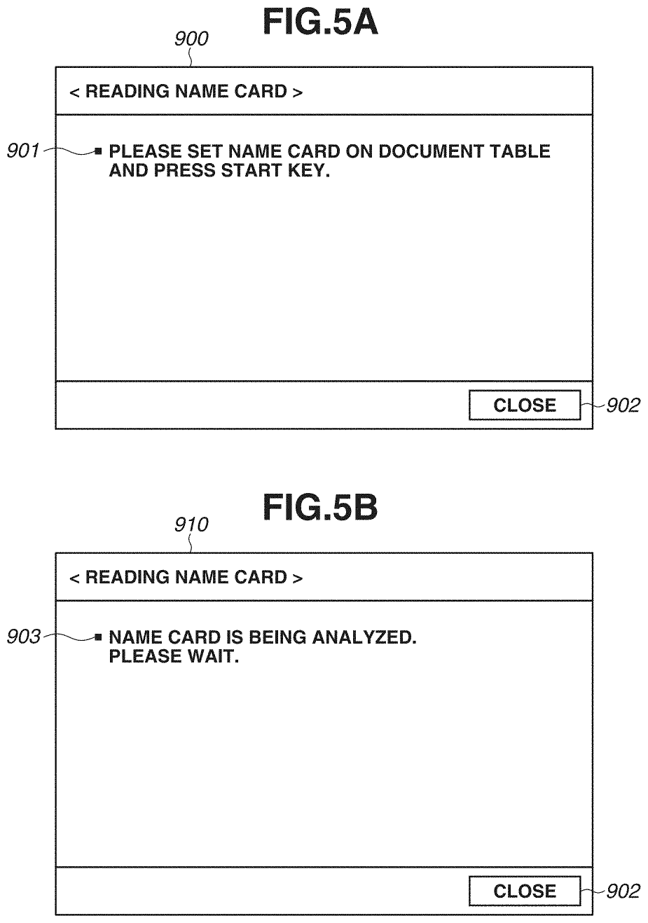

A name card reading screen 900 illustrated in FIG. 5A is displayed when the name card reading key 504 is selected (i.e., a name card reading function).

In FIG. 5A, the name card reading screen 900 displayed on the operation unit 116 when the name card reading key 504 in FIG. 4 is selected will be described.

A message 901 and a close key 902 are displayed on the name card reading screen 900 in FIG. 5A. When the close key 902 is selected, the name card reading screen 900 is closed, and reading of the name card ends. The message 901 prompts a user to start reading the name card through the reading unit 118.

In FIG. 5A, according to the message 901, when the user starts reading a name card through the MFP 101, the name card reading screen 900 shifts to a name card reading screen 910 illustrated in FIG. 5B. A message 903 notifying the user that reading of the name card is being executed is displayed on the name card reading screen 910.

Herein, the reading unit 118 executes name card reading processing for reading a name card placed on a document table of the MFP 101. Then, the CPU 111 executes optical character recognition (OCR) processing (character recognition processing) on the read image data. Further, the CPU 111 acquires name card information (e.g., an address, such as a fax number or an e-mail address, and a name) from a result of the OCR processing, and determines whether the acquired name card information is a fax address, an e-mail address, or a name (i.e., name card information acquisition processing).

Specifically, for example, since a name is likely to be displayed with a font that is the largest of the fonts used in the name card, the name can be determined from a size of the font. Further, information such as a number of characters can also be used for making the determination. For example, with respect to a fax number, an area including a character string such as “FAX” or “Facsimile” and a numerical string is extracted from a result of the OCR processing. Then, numerals included in the extracted area are regarded as a fax number and determined as an address. Alternatively, only a numerical string adjacent to the character string “FAX” or “Facsimile” can be extracted.

For example, with respect to an e-mail address, a portion of the e-mail address can be extracted from a result of the OCR processing based on a condition, such as a character string adjacent to “E-mail” or “Mail Address”, or a character string that includes a symbol “@”. A character string included in the extracted area is regarded as an e-mail address and determined as an address. Further, for example, with respect to a phone number, an area including a character string, such as “TEL” or “Phone Number,” and a numerical string is extracted from a result of the OCR processing. Then, numerals included in the extracted area are regarded as a phone number and determined as an address.

Alternatively, only a numerical string adjacent to the character string “TEL” or “Phone Number” can be extracted. Herein, although processing of reading a name card placed on a document table has been described, a configuration thereof is not limited thereto. For example, a name card can be fed and read through an automatic document feeder (ADF).

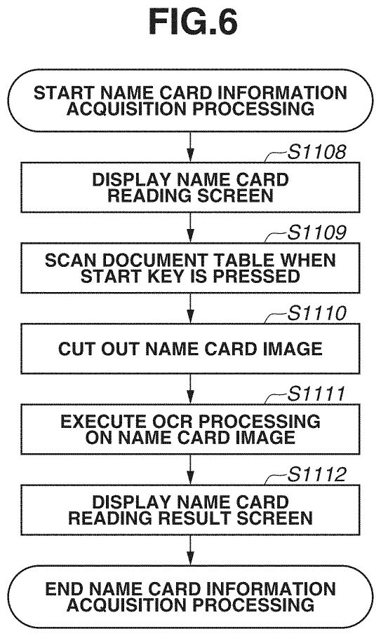

In FIG. 6, a flowchart illustrating name card information acquisition processing described in FIGS. 5A and 5B will be described. A program for executing the processing according to the flowchart in FIG. 6 is stored in the ROM 112 or the storage 114 in FIG. 2, read out to the RAM 113, and executed by the CPU 111.

When the name card information acquisition processing starts, in S1108, the CPU 111 displays the name card reading screen 900 on the operation unit 116. When the processing in S1108 ends, the processing proceeds to S1109.

In S1109, when the operation unit I/F 115 detects selection of a start key, the CPU 111 controls the reading unit 118 to execute reading of the document table to generate name card image data.

In S1110, with respect to the generated name card image data, the CPU 111 executes edge detection of name card image data from image shading information to cut out the name card image data, and saves the acquired name card image data in the storage 114. When the processing in S1110 ends, the processing proceeds to S1111.

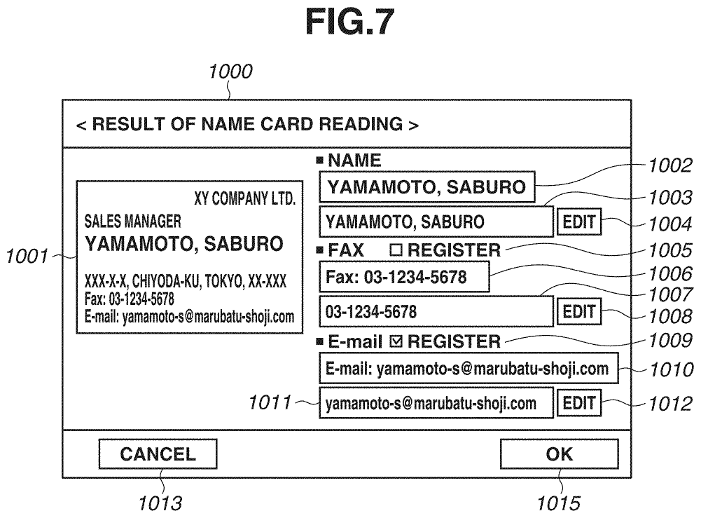

In S1111, the CPU 111 executes the OCR processing on the name card image data and stores acquired character information in the RAM 113. Then, as described above, the CPU 111 extracts a portion corresponding to a name, a fax number, and an e-mail address from the acquired character information. As illustrated in FIG. 7, which is described below, in the present exemplary embodiment, although a name card having no phone number is described as an example, the phone number can be described in the name card. When the processing in S1111 ends, the processing proceeds to S1112.

In S1112, the CPU 111 executes display processing for displaying a name card reading result screen 1000 illustrated in FIG. 7 on the operation unit 116. When the processing in S1112 ends, the name card information acquisition processing ends.

The name card reading result screen 1000, which is to be displayed on the operation unit 116 based on the information acquired through the OCR processing after execution of the name card information acquisition processing, will be described with reference to FIG. 7.

A name card screen 1001, a name 1002 as an enlarged image of a name, a fax number 1006 as an enlarged image of a fax number, and an e-mail address 1010 as an enlarged image of an e-mail address are displayed on the name card reading result screen 1000 in FIG. 7.

Further, a character information area 1003 for displaying character information of the name, a character information area 1007 for displaying character information of the fax number, and a character information area 1011 for displaying character information of the e-mail address are also displayed on the name card reading result screen 1000.

Furthermore, edit keys 1004, 1008, and 1012 for respectively editing the character information areas 1003, 1007, and 1011 are displayed on the name card reading result screen 1000. When the edit key 1004, 1008, or 1012 is selected, the CPU 111 displays a soft keyboard (not illustrated) for editing the character information. However, with respect to the character information area 1007 for displaying the character information of the fax number, editing can be executed through a numerical keypad (not illustrated) instead of the soft keyboard if the numerical keypad is arranged on the operation unit 116.

Further, checkboxes 1005 and 1009 are also displayed on the name card reading result screen 1000. When the checkbox 1005 or 1009 is selected, the operation unit 116 functions as an acceptance unit to accept selection of the corresponding address. The user selects whether to set the fax number as a transmission address through the checkbox 1005, and selects whether to set the e-mail address as a transmission address through the checkbox 1009. Herein, none of, only one of, or both of the checkboxes 1005 and 1009 can be selected. In the present exemplary embodiment, although selection is accepted by displaying a checkbox on the operation unit 116, a configuration is not limited thereto.

A cancel key 1013 and an OK key 1015 are displayed on the name card reading result screen 1000. The cancel key 1013 is a key for interrupting a setting of the transmission address halfway through and making the screen return to a screen as a transition source. In the present exemplary embodiment, when the cancel key 1013 is selected, the CPU 111 returns a display of the operation unit 116 to the transmission screen 500. In the present exemplary embodiment, although the CPU 111 returns a display of the operation unit 116 to the transmission screen 500, the display can be returned to the menu screen 400.

The OK key 1015 is selected when the user has confirmed or corrected the reading result, and has completed selection of the transmission address. When the OK key 1015 is selected, the CPU 111 shifts the screen to the next screen. For example, if the OK key 1015 is selected in a state where the checkbox 1009 is selected, the screen is shifted to the below-described transmission screen 510 in FIG. 8A (or 8B), and the CPU 111 inputs an e-mail address to the transmission screen 510 as a transmission address.

The transmission screen 510 in which the address selected in the screen in FIG. 7 is set as a transmission address will be described with reference to FIGS. 8A and 8B. An address specification key 505, a transmission information setting area 506, and a transmission address area 507 are displayed on the transmission screen 510 in FIG. 8A.

A transmission address set by the user is displayed on the transmission address area 507. In FIG. 8A, an e-mail address set through the name card reading function is set as a transmission address.

Then, the user makes a reading preparation of a document to be transmitted as image data through the reading unit 118. When the user selects a start key (not illustrated), the reading unit 118 executes reading, so that the generated image data is attached to an e-mail and transmitted to a transmission address.

As illustrated in FIG. 8B, an e-mail address as well as a fax number can be set as transmission addresses through the name card reading function. In this case, generated image data is attached to an e-mail and transmitted thereto, and the image data is also transmitted to the transmission address as a fax.

Further, as illustrated in FIG. 8C, a fax number can be set as an only transmission address through the name card reading function. In this case, generated image data is transmitted as a fax. Therefore, as illustrated in FIG. 8C, the transmission screen can be a fax transmission screen 520 displayed when the fax key 403 in FIG. 3 is selected. However, as illustrated in FIG. 8B, transmission can be executed through the transmission screen 510.

In the configuration described in the present exemplary embodiment, although a transmission address set by the name card reading function is set as the only transmission address, an address can be added thereto from an address book before transmission of image data is executed.

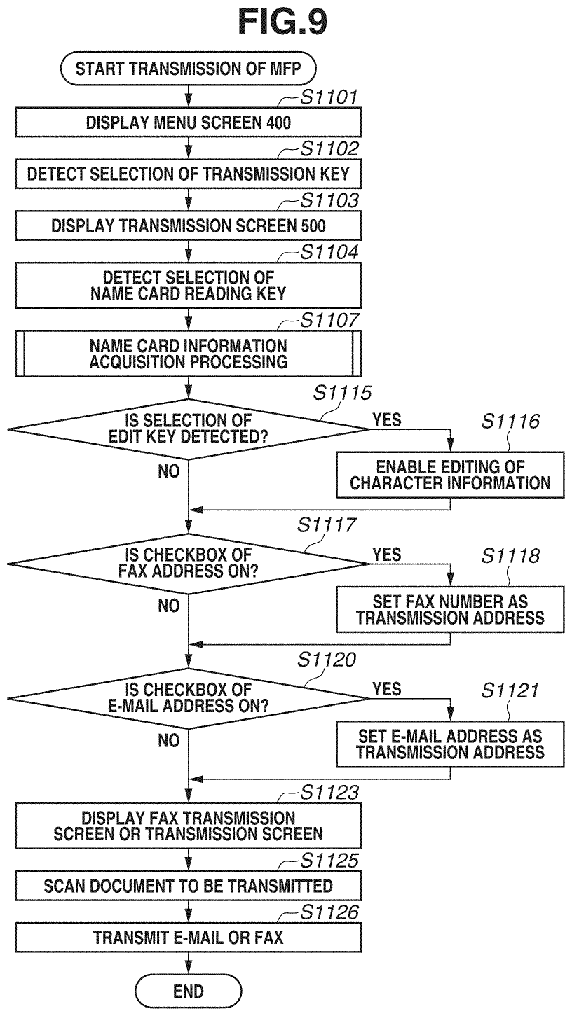

In FIG. 9, a flowchart illustrating transmission executed by the MFP in the present exemplary embodiment will be described. A program for executing the processing according to the flowchart in FIG. 9 is stored in the ROM 112 or the storage 114 in FIG. 2, read out to the RAM 113, and executed by the CPU 111.

In FIG. 9, firstly, in S1101, the CPU 111 displays a menu screen 400 on an operation panel 116 of the MFP 101.

In S1102, when the operation unit I/F 115 detects selection of the transmission key 402, the CPU 111 shifts the menu screen 400 to a screen for the transmission function.

In S1103, the CPU 111 displays the transmission screen 500 on the operation unit 116.

In S1104, when the operation unit I/F 115 detects selection of the name card reading key 504, the CPU 111 starts the name card information acquisition processing in S1107. The name card information acquisition processing has been described in FIG. 6. When the processing in S1107 ends, the processing proceeds to S1115.

In S1115, in a case where the operation unit I/F 115 detects selection of any one of the edit keys 1004, 1008, and 1012 (YES in S1115), the processing proceeds to S1116. In a case where the operation unit I/F 115 does not detect selection of any one of the edit keys 1004, 1008, and 1012 (NO in S1115), the processing proceeds to S1117.

In S1116, the CPU 111 displays a soft keyboard on the operation unit 116 to enable a user to edit the character information. Then, when the operation unit I/F 115 detects editing of the character information, the CPU 111 displays the edited character information on the operation unit 116. Then, when the operation unit I/F 115 detects selection of the OK key 1015, the processing proceeds to S1117.

In S1117, the CPU 111 detects whether the checkbox for setting the fax number as a transmission address is ON. In a case where the checkbox 1005 is ON (YES in S1117), the processing proceeds to S1118. In a case where the checkbox 1005 is OFF (NO in S1117), the processing proceeds to S1120.

In S1118, the CPU 111 saves the fax number in the RAM 113 as the transmission address.

In S1120, the CPU 111 detects whether the checkbox 1009 for setting the e-mail address as a transmission address is ON. In a case where the checkbox 1009 is ON (YES in S1120), the processing proceeds to S1121. In a case where the checkbox 1009 is OFF (NO in S1120), the processing proceeds to S1123.

In S1121, the CPU 111 saves the e-mail address in the RAM 113 as the transmission address.

In S1123, the CPU 111 displays the fax transmission screen 520 or the transmission screen 510 on the operation unit 116. As described above, in a case where only the fax number is set as the transmission address, the CPU 111 displays the fax transmission screen 520. In a case where only the e-mail address is set thereto, or if both of the e-mail address and the fax number are set thereto, the CPU 111 displays the transmission screen 510. When the processing in S1123 ends, the processing proceeds to S1125.

In S1125, the CPU 111 reads a document through the reading unit 118 to generate image data. When the processing in S1125 ends, the processing proceeds to S1126.

In S1126, with respect to the address displayed on the transmission screen 510 or the fax transmission screen 520 described in S1123, fax transmission of the image data or transmission of the e-mail to which the image data is attached is executed.

Through the above-described configuration, the user can read a name card and set an address selected from a plurality of addresses as a transmission address, so that operability of the user can be improved.

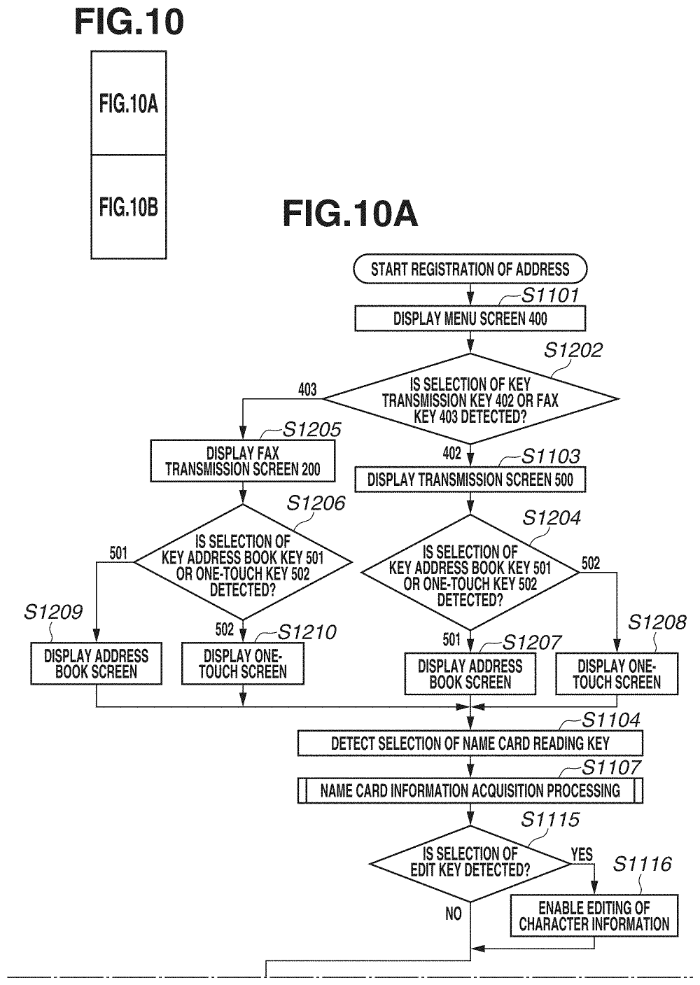

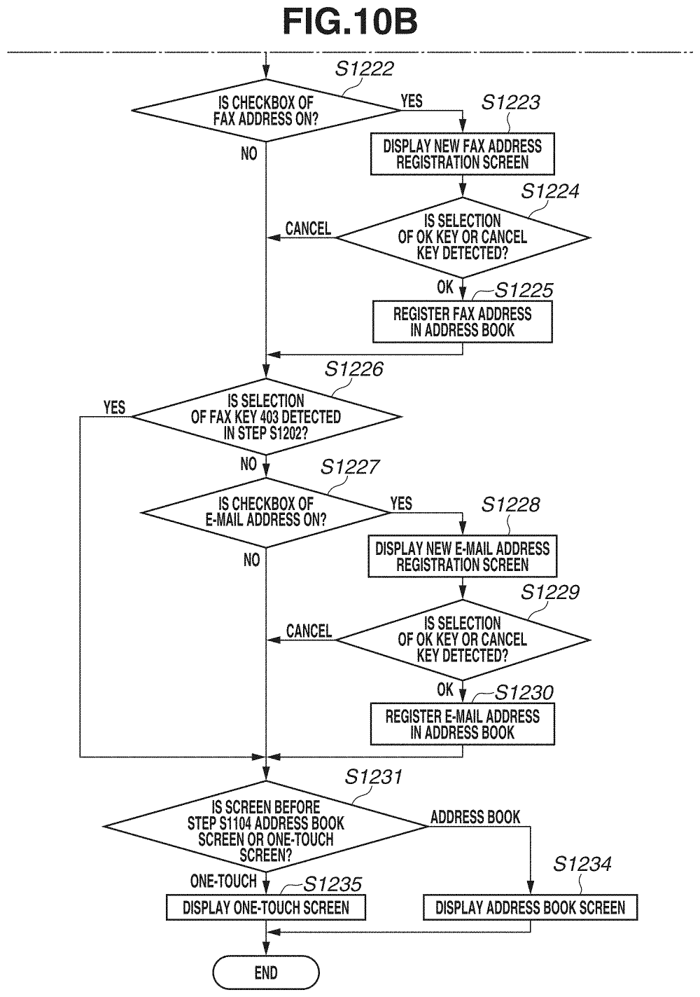

In FIG. 10, a flowchart illustrating address registration executed by the MFP of the present exemplary embodiment will be described. A program for executing the processing according to the flowchart in FIG. 10 is stored in the ROM 112 or the storage 114 in FIG. 2, read out to the RAM 113, and executed by the CPU 111. Further, the same reference number is applied to a processing similar to the processing in FIG. 9, and description thereof will be omitted.

In S1101, the CPU 111 displays the menu screen 400 on the operation unit 116 of the MFP 101.

In S1202, in a case where the operation unit I/F 115 detects selection of the transmission key 402 (“TRANSMISSION KEY 402” in S1202), the CPU 111 shifts the menu screen 400 to a screen for the transmission function. Then, the processing proceeds to S1103.

In S1103, the CPU 111 displays the transmission screen 500 illustrated in FIG. 4 on the operation unit 116. Then, the processing proceeds to S1204 from S1103.

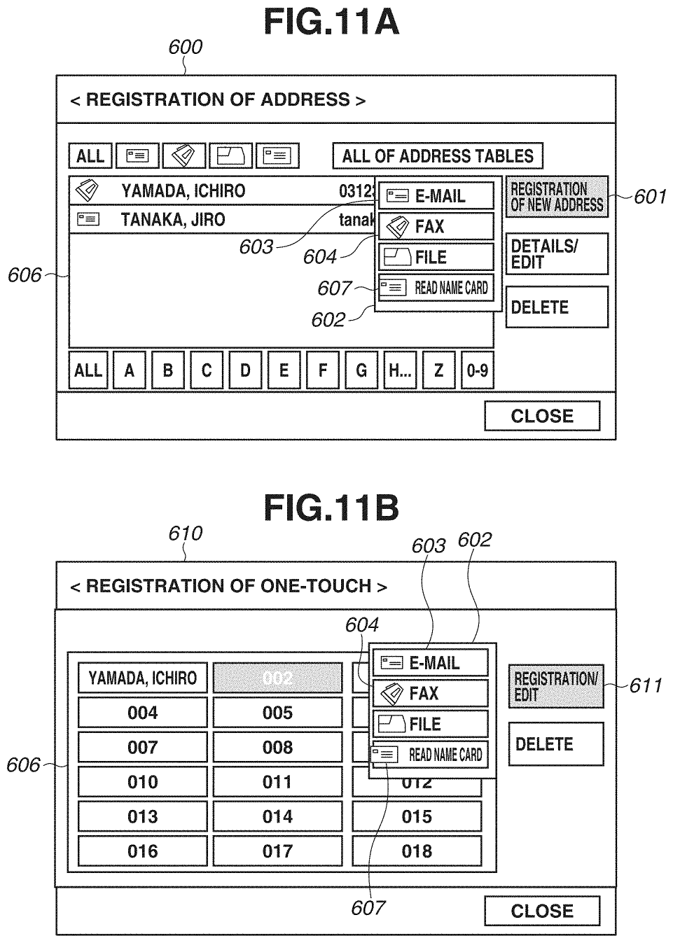

In S1204, in a case where the operation unit I/F 115 detects selection of the address book key 501 (“ADDRESS BOOK KEY 501” in S1204), the processing proceeds to S1207. In S1207, the CPU 111 displays an address book registration screen 600 illustrated in FIG. 11A. FIG. 11A illustrates a state where a registration key 601 of a new address displayed on the address book registration screen 600 is selected.

In FIG. 11A, registered addresses are displayed in an address display area 606. The registration key 601 is a key for registering a new address. When the registration key 601 is selected, a selection screen 602 is displayed. Keys such as an e-mail key 603 and a fax key 604, which allow the user to select a type of address to be registered or a mode of registration, are displayed on the selection screen 602. The e-mail key 603 is a key for registering an e-mail address. The fax key 604 is a key for registering a fax address. A name card reading key 607 is a key for starting reading of a name card.

Further, in the screen in FIG. 4, in a case where selection of the one-touch key 502 is detected (“ONE-TOUCH KEY 502” in S1204), the processing proceeds to S1208. In S1208, a registration screen 610 of the one-touch address book illustrated in FIG. 11B is displayed. In the screen in FIG. 11B, the user can select a predetermined registration number to register an address to that registration number. For example, in FIG. 11B, “YAMADA, ICHIRO” has already been registered in the registration number 001, and the registration number 002 is selected as a new registration destination. A registration/edit key 611 is a key for registering a new address, which corresponds to the registration key 601 of a new address.

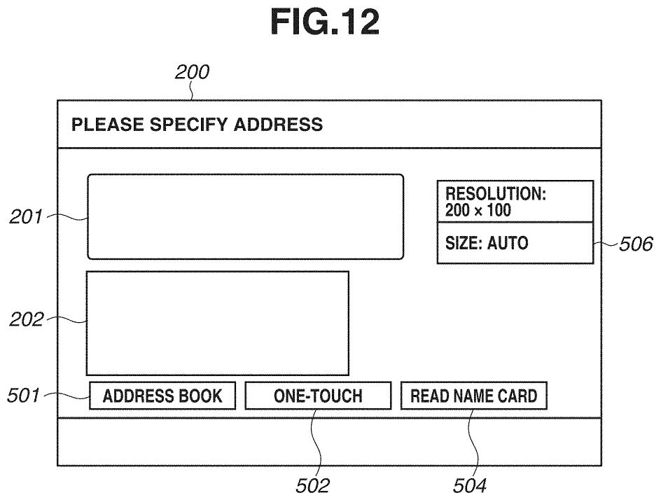

In S1202, in a case where the operation unit I/F 115 detects selection of the fax key 403 (“FAX KEY 403” in S1202), the CPU 111 shifts the menu screen 400 to a screen for the fax function. Then, the processing proceeds to S1205. In S1205, the CPU 111 displays a fax transmission screen 200 illustrated in FIG. 12 on the operation unit 116.

The fax transmission screen 200 illustrated in FIG. 12 is displayed when the fax key 403 in FIG. 3 is selected. An address display area 201, a one-touch area 202, an address book key 501, a one-touch key 502, and a name card reading key 504 are displayed thereon.

An address already set as a transmission destination is displayed in the address display area 201. An address that is already registered in the one-touch address book described below can be selected from the one-touch area 202. When the fax transmission screen 200 is displayed, the processing proceeds to S1206.

In S1206, in a case where the operation unit I/F 115 detects selection of the address book key 501 (“ADDRESS BOOK KEY 501” in S1206), the processing proceeds to S1209. In S1209, the CPU 111 displays the address book registration screen 600 illustrated in FIG. 11A. Herein, it is not necessary to display the e-mail key 603.

On the other hand, in S1206, in a case where the operation unit I/F 115 detects selection of the one-touch key 502 (“ONE-TOUCH KEY 502” in S1206), the processing proceeds to S1210. In S1210, the CPU 111 displays the registration screen 610 of the one-touch address book illustrated in FIG. 11B. Herein, it is not necessary to display the e-mail key 603.

In S1104, when the operation unit I/F 115 detects selection of the name card reading key 607 in the screen displayed in S1207, S1208, S1209, or S1210, the processing proceeds to S1107. Then, in S1107, the CPU 111 executes the name card information acquisition processing illustrated in FIG. 6.

When the processing in S1107 ends, the processing proceeds to S1115. The respective pieces of processing in S1115 and S1116 have already been described in FIG. 9, and thus description thereof is omitted. When the respective pieces of the processing in S1115 and S1116 end, the processing proceeds to S1222.

In S1222, the CPU 111 detects whether the checkbox for storing the fax number in the address book or the one-touch address book is ON.

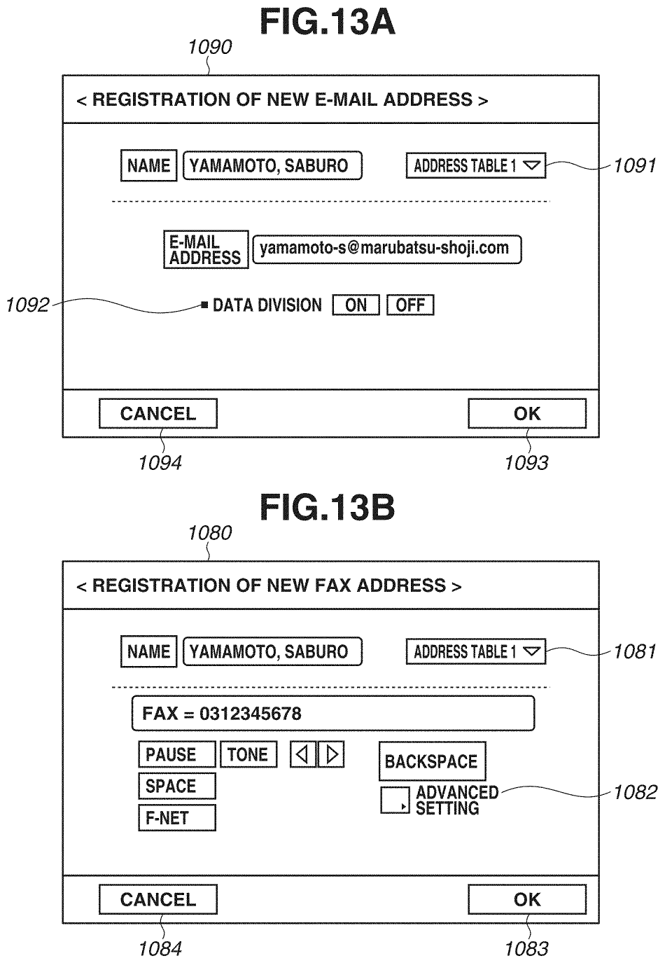

In S1222, in a case where the checkbox is ON (YES in S1222), the processing proceeds to S1223. In S1223, a new fax address registration screen 1080 in FIG. 13B is displayed. In the new fax address registration screen 1080 in FIG. 13B, content of an advanced setting 1082 can be registered in addition to the name and the fax number. For example, content of the advanced setting 1082 may be the information described in the transmission information setting area 525.

When the processing in S1223 ends, the processing proceeds to S1224. In S1224, in a case where the operation unit I/F 115 detects selection of the cancel key 1084 (“CANCEL” in S1224), the processing proceeds to S1226. On the other hand, in a case where the operation unit I/F 115 detects selection of the OK key 1083 (“OK” in S1224), the processing proceeds to S1225. In S1225, the fax address is registered in the address book or the one-touch address book. Then, the processing proceeds to S1226.

In S1226, in a case where the operation unit I/F 115 has detected selection of the fax key 403 in S1202 (YES in S1226), the processing proceeds to S1231. In a case where the operation unit I/F 115 has detected selection of the transmission key 402 (NO in S1226), the processing proceeds to S1227.

In S1227, the CPU 111 detects whether the checkbox for storing the e-mail address in the address book or the one-touch address book is ON.

In S1227, in a case where the checkbox is ON (YES in S1227), the processing proceeds to S1228. In S1228, a new e-mail address registration screen 1090 in FIG. 13A is displayed. In the new e-mail address registration screen 1090 in FIG. 13A, an address table selection list 1091 and a data division 1092 can be set in addition to a name and an e-mail address. Then, when an OK key 1093 is selected, registration is executed on the address book. In addition, content of the advanced settings (i.e., information described in the transmission information setting area 506) can be registered in the address book although the advanced setting is not illustrated in FIG. 13A.

When the processing in S1228 ends, the processing proceeds to S1229. In S1229, in a case where the operation unit I/F 115 detects selection of a cancel key 1094 (“CANCEL” in S1229), the processing proceeds to S1231. On the other hand, in a case where the operation unit I/F 115 detects selection of the OK key 1093 (“OK” in S1229), the processing proceeds to S1230. In S1230, an e-mail address is registered in the address book or the one-touch address book. Then, the processing proceeds to S1231.

If the number of addresses registered in the address book has already reached the maximum number, the address is not saved in the HDD 213, and an error is displayed on the operation unit 116.

In S1231, the CPU 111 returns a display of the operation unit 116 to a screen prior to execution of S1104. Specifically, in a case where the processing has been executed via S1207 or S1209 (“ADDRESS BOOK” in S1231), the processing proceeds to S1234. In S1234, the CPU 111 displays the address book registration screen 600 on the operation unit 116. On the other hand, in a case where the processing has been executed via S1208 or S1210 (“ONE-TOUCH” in S1231), the processing proceeds to S1235. In S1235, the CPU 111 displays the registration screen 610 of the one-touch address book on the operation unit 116.

Through the above configuration, the user can read a name card to register a selected address to the address book, so that operability of the user can be improved.

In the present exemplary embodiment, although a name card has been read in order to acquire a plurality of addresses, a configuration thereof is not limited thereto. For example, a plurality of addresses can be acquired by executing information acquisition processing described in S1107 with respect to an address table in which address information is organized or a predetermined sheet on which a name and an address are described. In this case, as illustrated in FIGS. 5A and 5B, document information (e.g., an address, such as a fax number or an e-mail address, and a name) is firstly acquired from a result of the OCR processing. Then, the CPU 111 determines whether the acquired document information is a fax address, an e-mail address, or a name to acquire address information.

Further, in the present exemplary embodiment, a configuration in which one e-mail address is described in the name card has been described. However, a plurality of e-mail addresses can be described, and each of the e-mail addresses can be selectable in the name card reading result screen. The same can also be said for the fax number.

Furthermore, in the present exemplary embodiment, although the operation unit is included in the image transmission apparatus, a configuration thereof is not limited thereto. For example, the operation unit can be included in an information terminal, such as a PC capable of connecting to the image transmission apparatus through communication.

### OTHER EMBODIMENTS

Some embodiment(s) can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that the claims are not limited to the disclosed exemplary embodiments. The scope of the following claims is to be accorded the broadest interpretation so as to encompass all such modifications and equivalent structures and functions.

What is claimed is:

1. An image transmission apparatus comprising:
a reading unit configured to read a document to generate image data;
a character recognition unit configured to recognize character information of the image data;
an acquisition unit configured to acquire a plurality of addresses from the character information recognized by the character recognition unit;
a selecting unit configured to select an address from among a plurality of addresses acquired by the acquisition unit; and
a setting unit configured to set the address selected by the selecting unit as a transmission address.
